(19) United States
(12) Patent Application Publication
(10) Pub. No.: US 2007/0056999 A1
(43) Pub. Date: Mar. 15, 2007

(54) Universal tool carrier

(76) Inventor: Peter Kahn, Brookhaven, NY (US)

Correspondence Address: KENNETH F. PEARCE, 631 DENMARK DRIVE, DANVILLE, KY, 40422-2419, US

(21) Appl. No.: 11/224,371

(22) Filed: Sep. 12, 2005

(51) Int. Cl. A45F 5/00; A45F 3/14; E06C 7/14; E04G 3/00

(52) U.S. Cl. 224/250; 224/269; 182/129; 248/210

(57) ABSTRACT

A universal tool carrier can provide the user the ability of carrying a tool or object in a manner that frees the user's hands when the tool or object is not being utilized. Among other things, the universal tool carrier includes a ring like member and receptacle combination that employs a cord for clutching the object to be carried. The ring can reciprocate with a multitude of receivers, e.g., a hook.

### BACKGROUND OF THE INVENTION

A. Field of the Invention

The universal tool carrier and method of using the universal tool carrier can provide the user the ability of carrying a tool or object in a manner that frees the user's hands when the tool or object is not being utilized. Among other things, the universal tool carrier includes a ring like member and receptacle combination that employs a cord for clutching the object to be carried. The receptacle can also be provided with an inwardly projecting rim for restraining the gravitational sway of the bungee wrapped about a portion of the tool or object carried by the universal tool carrier. The ring like member is designed to reciprocate with a multitude of receivers. And the receivers can be associated with a worker's belt or an apparatus capable of supporting the worker, such as a ladder.

B. Description of the Previous Art

1) U.S. Pat. No. 6,880,794—Kahn enables a universal tool holder. Kahn teaches that cord 12 is wrapped around the tool to be held. Prior to wrapping the tool, via locking spacer 15 and crimp 17, cord 12 is connected to ball 16. Thereafter, ball 16 is coupled with socket 25 to suspend the tool. The '794 Patent is does not disclose, teach or suggest a ring or a hook.

2) U.S. Pat. No. 1,833,690—Penners enables a holder for buckets. The Penner device hooks over a ladder's rung to hold a paint bucket. The '690 Patent is does not teach or suggest a holder for hand tools.

3) U.S. Pat. No. 2,361,069—Steinhardt enables a retaining device. The rigid Steinhart key ring does not teach or suggest a holder for hand tools.

4) U.S. Pat. No. 2,379,378—Rousseau enables a combined supporting ring and safety closure device for fire extinguishers. The rigid Rousseau fire extinguisher holder does not teach or suggest a holder for hand tools.

5) U.S. Pat. No. 3,131,900—Anderson, et al. enables a self leveling paint can holder attachment for ladders. The rigid Anderson paint can holder attachment does not teach or suggest a holder for hand tools.

6) U.S. Pat. No. 3,223,369—Benninger, Jr. enables a ladder attachment that is inserted into the ladder's rung for supporting a pail. The '369 Patent does not teach or suggest a holder for hand tools.

7) U.S. Pat. No. 3,239,181—Ellerbrock enables a paint can holder. The rigid Ellerbrock paint can holder attachment does not teach or suggest a holder for hand tools.

8) U.S. Pat. No. 3,246,867—Ewing enables a receptacle holder. The adjustable Ewing paint can holder does not teach or suggest a holder for hand tools.

9) U.S. Pat. No. 4,025,016—Brothers enables a ladder attachment. The rigid Brothers clamping block is attached to a ladder for carrying a paint bucket. The ‘Brothers clamping block does not teach or suggest a holder for hand tools.

10) U.S. Pat. No. 4,036,463—Hopkins, et al. enables a combination paint can and brush receptacle. Hopkins does not teach or suggest a cord wrapped around a hand tool.

11) U.S. Pat. No. 4,186,903—Fazakerley enables a painter's fixture. The '903 device is an insert for a hollow of a ladder that includes a pivoting arm for holding the paint bucket. Fazakerley does not teach or suggest a cord wrapped around a hand tool.

12) U.S. Pat. No. 4,455,717—Gray enables a rope clamp. Gray does not teach or suggest a cord wrapped around a hand tool or a manner of suspending the took from a hook.

13) U.S. Pat. No. 4,662,954—Fedoris enables a method for improving base coating formation on silicon steel by controlling winding tension. Fedoris does not teach or suggest a holder for hand tools.

14) U.S. Pat. No. 4,884,824—Radke enables a magnetic fender cover. Radke does not teach or suggest a holder for hand tools.

15) U.S. Pat. No. 5,020,192—Gerlach enables an adjustable tie down apparatus and method. The Gerlach tie down does not teach or suggest a holder for hand tools.

16) U.S. Pat. No. 5,118,064—Gonsalves enables an anti-spatter container mounting and actuating device. Gonsalves teaches the application of anti-spatter formulation to the cone of a MIG welding gun with minimal disruption of the welding operator's activity. The '064 Patent does not teach or suggest a holder for hand tools.

17) U.S. Pat. No. 5,697,128—Peregrine enables a loop fastener device having an elasticized cord and a slidable lock element. The '128 ends 17, 18 of cord 10 are looped and then passed through a generally circular, or elliptical, opening or bore 12 formed in the generally cylindrical housing 106 of a locking device 15. Plunger 16 is spring biased and allows locking device to be manually moved along the two runs of cord. Once the desired size loop is formed about an object, and cord 10 is stretched a desired amount, plunger 16 is released. The holding force of locking device 15 is dependent only the spring bias of plunger 16. Peregrine does not disclose, teach or suggest a ring or a hook for suspending a hand tool.

18) U.S. Pat. No. 5,743,452—Kahn, owned by Applicant, enables tool belt tote tool. The '454 Patent does not disclose, teach or suggest a ring or a hook for suspending a hand tool by a cord.

19) U.S. Pat. No. 5,791,022—Bohman enables a cord locking mechanism. The '022 lock includes a slit 5 for securely causing tension on a portion of the cord. Bohman does not teach or suggest a holder for hand tools.

20) U.S. Pat. No. 5,806,822—Schulz enables a holder for a medical suction instrument. Schulz does not disclose, teach or suggest a ring and rope combination for suspending a hand tool.

21) U.S. Pat. No. 5,842,584—Baird enables a strap-on drill paraphernalia holding system and method. Baird does not teach or suggest a holder for hand tools.

22) U.S. Pat. No. 6,062,449—Kahn, owned by Applicant, enables tool belt tote tool. The '449 Patent does not disclose, teach or suggest a ring or a hook for suspending a hand tool by a cord.

23) U.S. Pat. No. 6,254,045—Oatsvall enables an extension ladder supply container. The '045 ladder supply container does not teach or suggest a ring or a hook for suspending a hand tool by a cord.

24) U.S. Pat. No. 6,338,459—Biggs enables a paint bucket holder for a ladder. Biggs does not teach or suggest a holder for hand tools.

25) U.S. Pat. No. 6,443,342—Kahn, owned by Applicant, enables tool belt double tote tool. The '342 Patent does not disclose, teach or suggest a ring or a hook for suspending a hand tool by a cord.

26) U.S. Pat. No. 6,496,094—May, III enables a magnet clamp for hand tools. May does not teach or suggest a holder for hand tools.

### SUMMARY OF THE INVENTION

The present universal tool carrier and method of using the universal tool carrier are directed toward carrying a worker's tools, hand tools or other objects found in the worker's work environment. The simple structures disclosed herein enable the practice of unique universal tool carrier embodiments, within the scope of the present invention. The believed heretobefore unknown combination of a ring like member, conical receptacle and bungee cord meet the previously unfulfilled but long felt need of allowing the worker to readily hook the ring like member to a receiver so that the combination can carry the worker's tool or other object. Thus, the worker's hands can be freed from carrying the tool or other object—allowing the worker to accomplish other tasks while having the tool or other object within arm's reach.

It is an aspect of the present invention to provide a universal tool carrier which can be removably attached to most any tool or object.

It is another aspect of the present invention to provide a ring and receptacle combination capable of functioning with a plethora of receivers.

It is still another aspect of the present invention to provide an embodiment of a universal tool carrier that can function with a clip of the worker's belt.

It is yet another aspect of the present invention to provide an embodiment of a universal tool carrier that can function with an apparatus capable of supporting the worker.

It is another aspect of the present invention to enable a method for using the universal tool carrier.

It is still another aspect of the present invention to provide an embodiment of a bungee cord with sufficient recoil capacity to cause at least a part of the object clutched by the bungee cord to abut the receptacle of the universal tool carrier as the object is carried by the universal tool carrier.

It is yet another aspect of the present invention to provide an embodiment of a conically shaped receptacle that includes a inwardly projecting rib.

It is still another aspect of the present invention to provide an embodiment of a universal tool carrier capable of minimizing gravitational sway of the object carried by the universal tool carrier.

An embodiment of the present invention can be described as a universal tool carrier for carrying a tool comprising: a bungee cord; a combination ring and conical receptacle, wherein the conical receptacle further comprises: an opening opposite said ring, a catch and an inwardly projecting rib; a holder correspondingly engaging the catch, wherein the holder crimps each end of the bungee cord; and a receiver for carrying the combination ring and conical receptacle.

Another embodiment of the present invention can be described as a system for carrying a tool comprising: an apparatus capable of supporting a worker; a receiver inserted into a hollow of the apparatus; a ring and a receptacle cooperating with the receiver, where the receptacle further comprises: a catch and an inwardly projecting rib; a holder correspondingly engaging the catch, wherein the holder crimps each end of a bungee creating a first loop; and a second loop formed from said first loop for securely gripping a portion the tool.

Yet another embodiment of the present device can be described as a method of carrying a object with a universal tool carrier, comprising the steps of: extending a first bungee loop from the universal tool carrier; bending the first bungee loop about an object to be securely grasped; pulling the universal tool carrier through the first bungee loop such that a second and smaller bungee loop is created from the first bungee loop, wherein the second and smaller bungee loop clutches the object tool; and connecting the universal tool carrier to a receiver such that the first bungee loop can recoil to where the object abuts the universal tool carrier, wherein the universal tool carrier comprises: a ring and a conical receptacle communicating with the ring.

It is the novel and unique interaction of these simple elements which creates the universal tool carriers and methods, within the ambit of the present invention. Pursuant to Title 35 of the United States Code, descriptions of preferred embodiments follow. However, it is to be understood that the best mode descriptions do not limit the scope of the present invention.

### BRIEF DESCRIPTION OF THE DRAWINGS

FIG. 1 is an exploded view of a perspective of an embodiment of universal tool carrier, within the scope of the present invention.

FIG. 2 is a perspective showing the inward side of a door, within the scope of the present invention.

FIG. 3 is a perspective of an embodiment of combination ring and receptacle and C-clip, within the scope of the present invention.

FIG. 4 is a perspective an embodiment of a second loop gripping a handle, within the scope of the present invention.

FIG. 5. is a first exploded perspective of an embodiment of a receiver, within the scope of the present invention.

FIG. 6 is a second exploded perspective of the embodiment of the receiver portrayed in FIG. 5.

FIG. 7 is a perspective of a receiver, within the scope of the present invention, that can be inserted into the hollow of an apparatus where the apparatus is capable of supporting the worker.

FIG. 8 is an illustration of the steps of an embodiment of the present method.

FIG. 9 is a depiction of the steps of another embodiment of the present invention.

FIG. 10 is an exemplification of the steps of yet another embodiment of the current method.

FIG. 11 is another illustration of the steps of an embodiment of the present method.

### DESCRIPTION OF THE PREFERRED EMBODIMENTS

Although the disclosure hereof is detailed to enable those skilled in the art to practice the invention, the embodiments published herein merely exemplify the present invention.

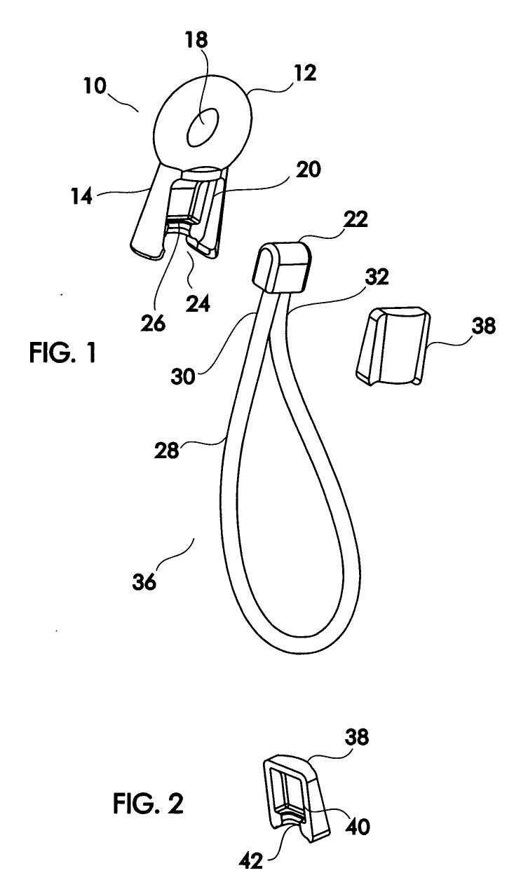

FIG. 1 is an exploded view of a first perspective of an embodiment of the present invention. Combination ring and receptacle (10) includes a ring-like member (12) and conically shaped receptacle (14). Ring-like member (12) is provided with aperture (18) for engaging a receiver (not shown in this view). Ring-like member ring (12) and generally conically shaped receptacle (14) are connected in any manner acceptable in the art, or combination ring and receptacle (10) can be an molded unit. As shown FIG. 1, combination ring and receptacle (10) is a fuse molded unit made of a durable plastic material.

Generally conically shaped receptacle (14) includes catch (20) for correspondingly engaging holder (22). Generally conically shaped opening (24) of conically shaped receptacle (14) is distal from ring-like member (12) and circumscribes cord (28), when combination ring and receptacle is fully assembled. Proximate conically shaped opening (24) is inwardly projecting rib (26) for contacting bungee (28).

Depending from holder (22) is cord or bungee (28) having a first end (30) and a second end (32) crimped by holder (22). Crimping or holding of each end (30) and (32) creates first loop (36) of bungee (28). Door (38) secures holder (22) in catch (20). When first loop (36) is extended its first side is proximate combination ring and receptacle (10) and its second side is distal from combination ring and receptacle (10).

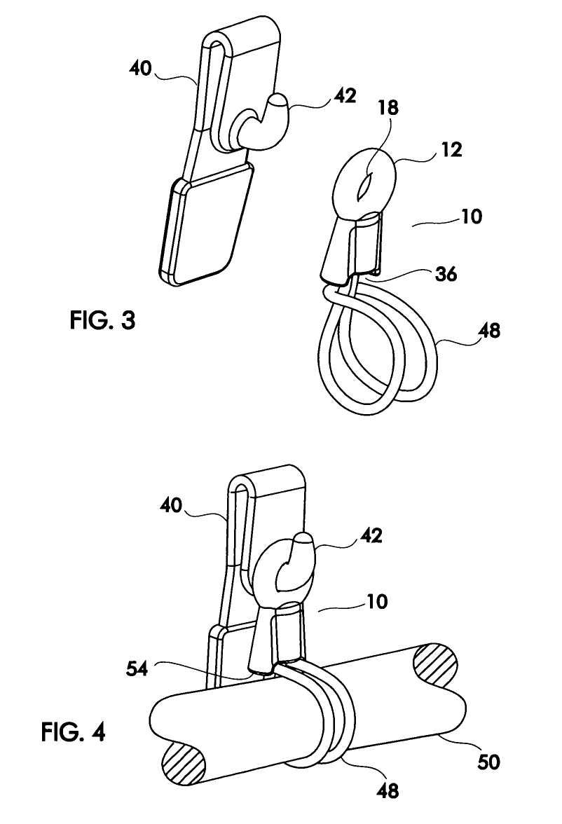

FIG. 2 is a perspective showing the inward side of door (38). Door (38) can include catch (40) and inwardly projecting rib (42). Door (38) can be fuse molded to conically shaped receptacle (14) or door (38) can be attached to conically shaped receptacle (14) in any other manner acceptable in the art.

FIG. 3 is a perspective of an embodiment of combination ring and receptacle (10) and C-clip (40) of the present invention. C-clip (40) can be attached to a worker's belt and is provided with hook-like receiver (42) for engaging aperture (18) of ring-like member (12). FIG. 3 also discloses second and smaller loop (48) formed from first loop (36). Second and smaller loop (48) is created by pulling the first side of first loop (36) through a second side of first loop (36). As shown in FIG. 4, second loop (48) can grip handle (50) of a power tool or other tool. Due to the resilient properties of bungee (28), first loop (36) can cause handle (50) to abut lower edge of (54) of combination ring and receptacle (10).

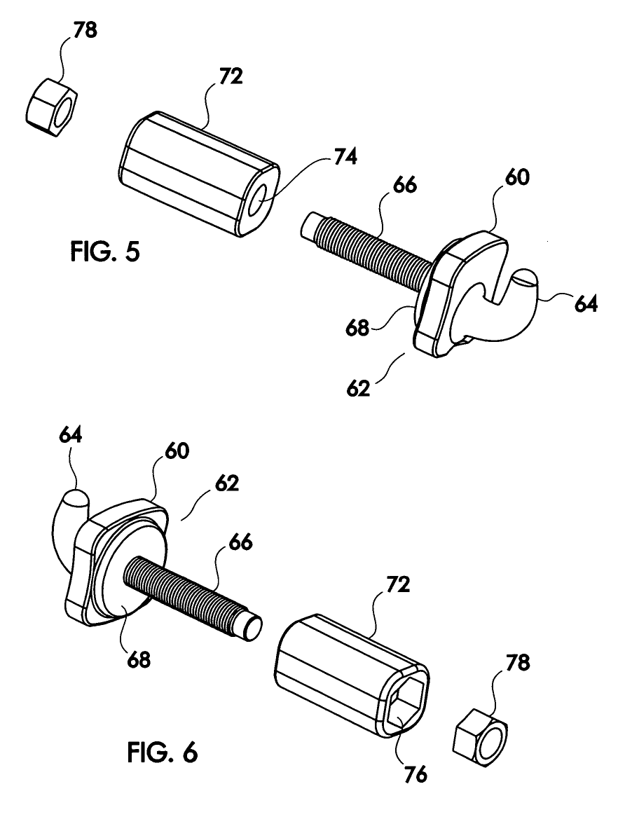

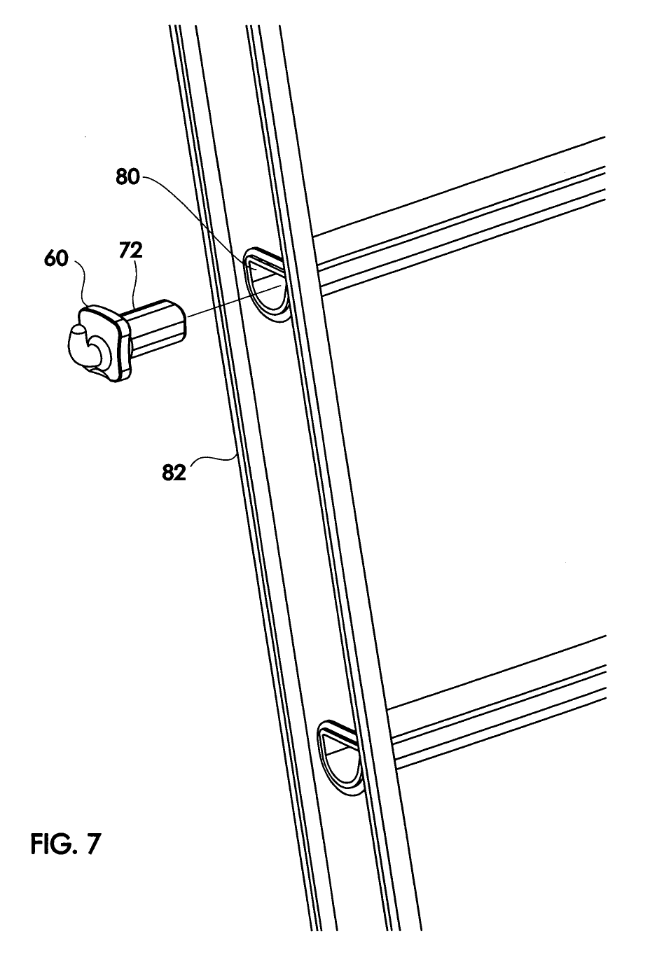

FIG. 5. is a first exploded perspective of an embodiment of a receiver of the present invention and FIG. 6 is a second exploded perspective of the embodiment of the receiver portrayed in FIG. 5. Receiver (60) includes threaded rod (62) having a hook (64) at an end opposite threads (66). Raised surface (68) is located proximate hook (64). Elastic plug (72) is provided with bore (74) for receiving threaded rod (62) and recess (76) for holding nut (78).

As shown in FIG. 7, receiver (60) and elastic plug (72) can be inserted into hollow (80) of ladder (82). After receiver (60) and elastic plug (72) are inserted into hollow (80), raised surface (68) can be tightened against nut (78) causing elastic plug (72) to expand against the inner dimensions of hollow (80) to secure receiver (60) such that receiver (60) can receive aperture (18) of ring-like member (12) of combination ring and receptacle (10). Receiver (60) and plug (72) can function with any apparatus having a hollow or capable of supporting a worker.

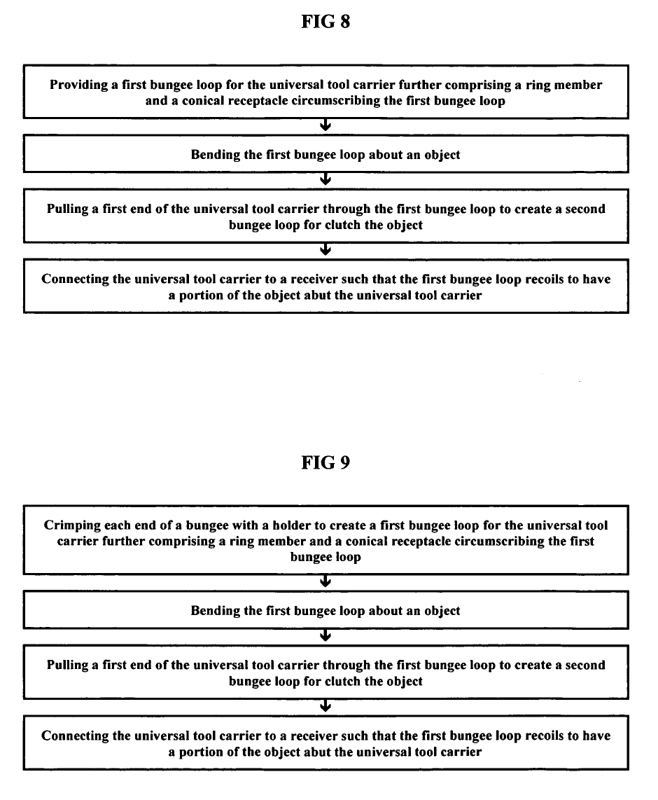

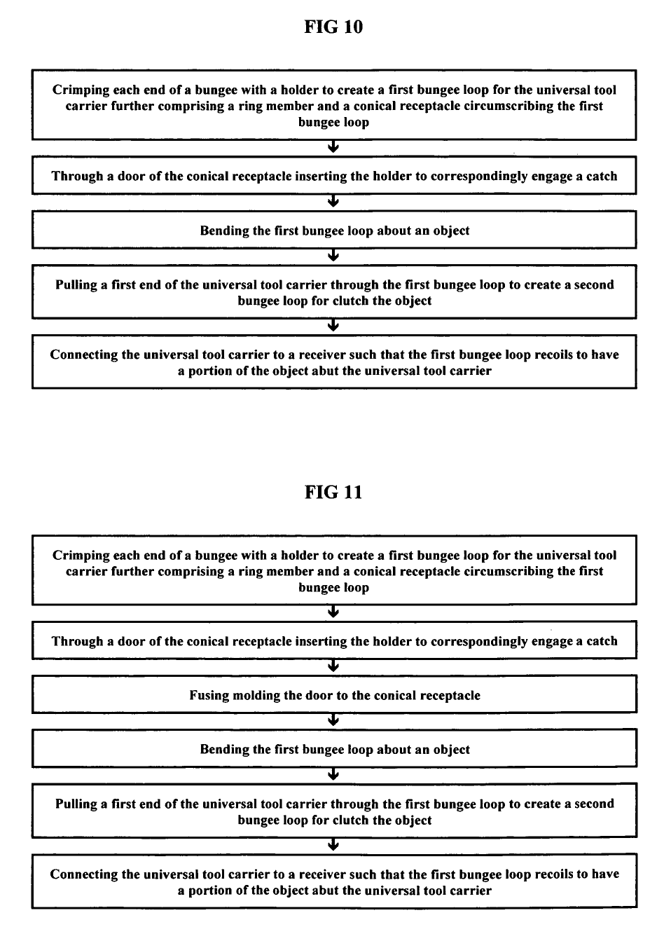

Steps associated with the methods of practicing the present invention are depicted in FIGS. 8-11.

Having disclosed the invention as required by Title 35 of the United States Code, Applicant now prays respectfully that Letters Patent be granted for his invention in accordance with the scope of the claims appended hereto.

What is claimed is:

1) A universal tool carrier for carrying a tool comprising:
a) a bungee cord;
b) a combination ring and generally conical receptacle, wherein said generally conical receptacle further comprises:
i) an opening opposite said ring;
ii) a catch; and
iii) an inwardly projecting rib positioned proximate said opening and circumscribing and inward side of said generally conical receptacle;
c) a holder correspondingly engaging said catch, wherein said holder crimps each end of said bungee cord creating a first loop such that when said first loop is extended said first loop has a first side proximate said combination and circumscribed by said opening and a second side distal from said combination;
d) a second and smaller loop formed from said first loop for securely grasping a portion said tool when said first side is pulled through second side such that said tool can abut said combination ring and receptacle when said tool is suspended by said first loop and said second and smaller loop; and
e) a receiver for carrying said combination ring and conical receptacle.

2) The invention of claim 1 further comprising a door.

3) The invention of claim 2, wherein said receiver is a hook.

4) The invention of claim 2, wherein said receiver further comprises:
a) a clip for clipping a workman's belt; and
b) a hook at an end of said clip.

5) The invention of claim 4 wherein said clip is a C-shaped clip.

6) A system for carrying a tool comprising:
a) an apparatus capable of supporting a worker, wherein said apparatus further comprises one or more hollows;
b) a receiver inserted into at least one of said hollows;
c) a combination cooperating with said receiver; said combination comprising a ring and a receptacle, wherein said receptacle further comprises:
i) an opening opposite said ring;
ii) a catch; and
iii) an inwardly projecting rib positioned proximate said opening;
d) a holder correspondingly engaging said catch, wherein said holder crimps each end of a bungee creating a first loop such that when said first loop is extended said first loop has a first side proximate said combination and circumscribed by said opening and a second side distal from said combination; and
e) a second loop formed from said first loop for securely gripping a portion said tool when said first side is pulled through said second side, whereby said tool can abut said combination ring and receptacle as said tool is carried.

7) The system of claim 6, wherein said an apparatus capable of supporting a worker is a ladder and said one or more hollows are located within one or more corresponding rungs.

8) The system of claim 7, wherein said receiver further comprises:
a) an elastic plug for securely engaging an internal surface of one or more of said corresponding rungs, wherein said elastic plug further comprises a bore;
b) a threaded rod including a hook at one end;
c) a washer; and
d) a nut.

9) The invention of claim 8, wherein said receptacle further comprises a door.

10) The invention of claim 9, wherein said receptacle is generally cone-shaped with said receptacle's greater circumference being distal from said ring.

11) The invention of claim 10, wherein said inwardly projecting rib circumscribes said inward side of said cone-shaped receptacle.

12) A method of carrying an object with a universal tool carrier, comprising the steps of:
a) providing a first bungee loop for said universal tool carrier;
b) bending said first bungee loop about an object to be securely grasped;
c) pulling a first end said universal tool carrier through said first bungee loop such that a second and smaller bungee loop is created from said first bungee loop, wherein said second and smaller bungee loop clutches said object; and
d) connecting said universal tool carrier to a receiver such that said first bungee loop can recoil to where said object abuts said universal tool carrier, wherein said universal tool carrier further comprises:
i) a ring for engaging said receiver;
ii) a generally conical receptacle communicating with said ring, wherein said generally conical receptacle further comprises:
A) an inwardly raised rib about an inward side of said generally conical receptacle; and
B) a catch for engaging said first bungee loop.

13) The method of claim 12 further comprising the step of crimping each end of a bungee with a holder to create said first bungee loop.

14) The method of claim 13 further comprising the step of inserting said holder into said catch via an open door of said conical receptacle.

15) The method of claim 14 further comprising the step of fuse molding said door to said conical receptacle.

16) The method of claim 15 further comprising the step of connecting said receiver about a worker's belt.

17) The method of claim 15 further comprising the step of connecting said receiver about an apparatus capable of supporting a worker.

18) A universal tool carrier for carrying a tool comprising:
a) a cord;
b) a combination ring and receptacle, wherein said receptacle further comprises:
i) a catch; and
ii) an opening opposite said ring;
c) a holder correspondingly engaging said catch, wherein said holder holds each end of said cord creating a first loop such that when said first loop is extended said first loop has a first side proximate said combination and circumscribed by said opening and a second side distal from said combination; and
d) a second loop formed from said first loop for securely gripping a portion of said tool when said first side is pulled through said second side, whereby said tool can be suspended from said combination ring and receptacle.

19) The invention of claim 18 further comprising a receiver for carrying said combination.

20) The invention of claim 19, wherein said receiver communicates with a worker's belt or an apparatus suspending said worker.
